(19) United States
(12) Patent Application Publication
(10) Pub. No.: US 2013/0000485 A1
(43) Pub. Date: Jan. 3, 2013

(54) Flow Control System, Device and Method for Thermal Desorption

(76) Inventors: Andrew Tipler, Trumbull, CT (US); Greg Johnson, Thame (GB); David J. Scott, Wallingford, CT (US)

(21) Appl. No.: 13/172,263

(22) Filed: Jun. 29, 2011

(51) Int. Cl. B01D 53/04

(52) U.S. Cl. 95/87; 96/101; 95/82

(57) ABSTRACT

A flow control system, method and device for performing thermal desorption is provided. In one embodiment, the system includes a first flow path in which gas flows from a first carrier gas inlet, through a first vessel in a first direction at a first flow rate to adsorb analytes on an adsorbent of said first vessel; a second flow path in which gas flows from a second carrier gas inlet, through said first vessel in the first direction at a second flow rate to further adsorb the analytes on the adsorbent of said first vessel; a third flow path in which a carrier gas flows through said first vessel in a second direction to carry desorbed analytes out of said first vessel; and wherein the second flow rate of carrier gas through said first vessel is greater than the first flow rate of carrier gas through said first vessel.

### BACKGROUND OF THE INVENTION

The present invention generally relates to systems, methods and devices for providing flow control, and more particularly for regulating flow control and throughput of a thermal desorption autosampler.

Gas chromatography is essentially a physical method of separation in which constituents of a vapor sample in a carrier gas are adsorbed or absorbed and then desorbed by a stationary phase material in a column. Typically, the analytes to be measured are retained by and concentrated on an adsorbent in a sample tube.

Once the analytes are collected in the sample tube, the tube is then transported to a thermal desorption unit, where the tube is placed in the flow path of an inert gas, such as helium or nitrogen. The tube is subsequently heated, thereby desorbing the analytes, and the carrier gas sweeps the analytes out of the tube. In some cases, a trap is located downstream of the sample tube in order to further pre-concentrate the analytes, and occasionally, remove moisture therefrom, prior to introducing the sample into the chromatographic column. One example of such a trap is an adsorbent trap, usually cooled to a sub-ambient temperature, which may simply be another sorbent tube with a suitable adsorbent material. The adsorbent trap adsorbs the analytes as the sample gas first passes through the tube. The analytes are then subsequently desorbed into the chromatographic column from the trap, usually by heating, for subsequent separation and analysis. Typically, either the column is directly coupled to a sorbent tube in the thermal desorption unit or the unit is connected directly to the column via a transfer line, such as, for example, via a length of fused silica tubing.

It is frequently the case that a high concentration of analytes are present in the initial tube sampling which threatens to overload the analytical column and swamp detector response—neither of which is desirable. Splitting is a commonly applied strategy for responding to high concentrations of analyte present in the sample tube.

Inlet splitting is the technique where different flow rates are applied to two separate flow paths as the sample tube is desorbed with one flow path traversing through the trap and another flow path leading out an inlet vent. The analytes are then split in proportion with the ratio of the two flow paths. Instrument hardware limitations typically determine the maximum obtainable split ratio.

Outlet splitting is the technique where different flow rates are applied to two separate flow paths of the carrier gas carrying analytes that are desorbed from the trap. Typically, one flow path traverses through the transfer line and/or column (to be analyzed) and the other flow path leads out an outlet vent. Again, instrument hardware limitations will determine the maximum obtainable outlet split ratio of the two flows.

The inlet and outlet split ratios are compounded to give the overall dilution of the sample. For example, a 1:200 inlet split followed by a 1:200 outlet split would generate an overall split of approximately 1:40,000.

When using inlet splitting at a high split ratio to handle very concentrated samples, there is very little gas flow going through the trap during sample tube desorption. Consequently, the analytes do not travel very far into the trap adsorbents. Consequently, during flow equilibration prior to heating the trap, some of these analytes may not be immobilized on the trap adsorbent and therefore may be carried out of the trap and into the column causing a pre-injection and double peaks in the chromatography. Therefore, there is a need to “push” the analytes further into the trap at the end of tube desorption to ensure that analytes are not carried out of the trap and into the column at equilibration causing a pre-injection and double peaks in the chromatography. In addition, there is a need to push the analytes further into the trap in an efficient and cost effective manner. These and other needs may be addressed by various embodiments of the present invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities depicted in the drawings:

FIG. 1 is a schematic view of a system for providing flow control during sample tube desorption in accordance with an example embodiment of the present invention;

FIG. 2 is a schematic view of the system of FIG. 1 during a push cycle;

FIG. 3 is a schematic view of the system of FIG. 1 during trap desorption; and

FIG. 4 is a flow chart of a method for providing flow control in accordance with an example embodiment of the present invention.

### DETAILED DESCRIPTION OF ILLUSTRATIVE EMBODIMENTS

In the following description, for purposes of explanation and not limitation, specific details are set forth, such as particular valves, adsorbents, sensors, heating devices, gases, materials, analytes, configurations, devices, ranges, temperatures, components, techniques, vessels, samples, and processes, etc. in order to provide a thorough understanding of the present invention.

However, it will be apparent to one skilled in the art that the present invention may be practiced in other embodiments that depart from these specific details. Detailed descriptions of well-known valves, adsorbents, sensors, heating devices, gases, materials, analytes, configurations, devices, ranges, temperatures, components, techniques, vessels, samples, and processes are omitted so as not to obscure the description of the present invention. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

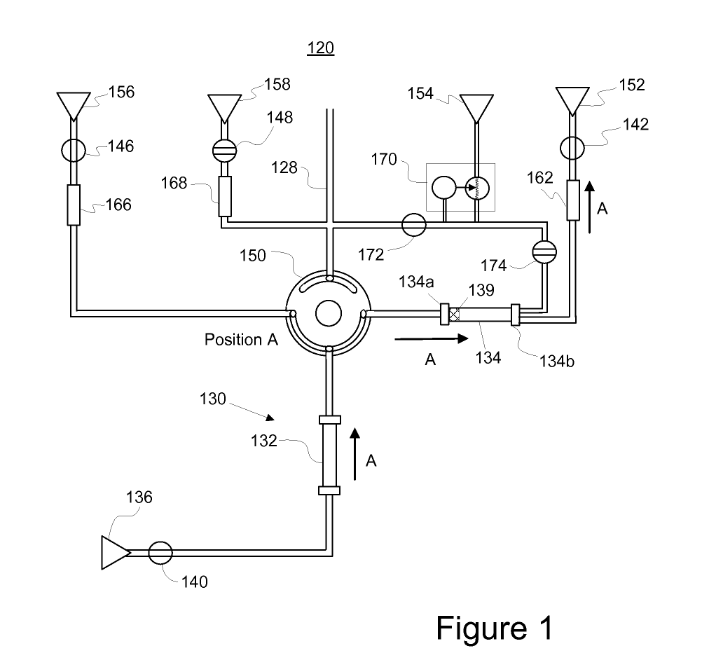

The basic components of one example embodiment of flow control system for a thermal desorption unit 120 for providing analytes to a gas chromatograph system via a transfer line 128 in accordance with the prevent invention are illustrated in FIG. 1. The thermal desorption unit 120 generally comprises a sample station 130, in which a sample vessel 132, such as a sorbent tube, is disposed. In addition, an adsorbent trap 134, such as another sorbent tube, is placed downstream of the sample tube 132 for further pre-concentration of the analytes. The tube 132, adsorbent trap 134, and transfer line 128 are selectively in communication with each other via a rotary valve 150. An inlet 136, such as for carrier gas, is selectively in fluid communication with the sample tube 132 via valve 140. A desorb vent 152 is selectively in fluid communication with the adsorbent trap 134 via charcoal trap 162 and valve 142. Another inlet 154 is in fluid communication with (e.g., supplies carrier gas to) programmable pneumatic control (PPC) 170, which is selectively in fluid communication with the transfer line 128 via valve 172. Programmable pneumatic control 170 is also selectively in fluid communication with a second side 134b of trap 134 via valve 174. An inlet vent 156 is selectively in fluid communication with the rotary valve 150 via a charcoal trap 166 and valve 146. An outlet vent 158 is selectively in fluid communication with the transfer line 128 via charcoal trap 168 and valve 148. As is evident from FIG. 1, this example embodiment incorporates a double split configuration (incorporates both inlet splitting and outlet splitting.). One example PPC that may be suitable for some embodiments of the present invention is PPC Part No. N610-0320 offered commercially by PerkinElmer Inc.

The operation of the system is illustrated in FIGS. 1-3. As shown in FIG. 1, a sample tube 132, which contains the analytes obtained from the environment to be tested, is disposed in the sample station 130 of the thermal desorption unit 120. The rotary valve 50 is in position A such that the sample tube 132 is in fluid communication with the trap 134, and valves 140, 172, and 146 are opened. Valves 148 and 174 are closed. Valve 148 may be closed (or opened) depending how the user is using the system. The tube 32 may be heated in order to desorb the analytes therefrom, and carrier gas flows in through inlet 136, through valve 140, through the tube 32, and sweeps the analytes in the first side 134a of the trap 134 (as indicated by arrows A). An adsorbent disposed in the trap 134 adsorbs the analytes, and the carrier gas flows out through the charcoal trap 162, valve 142 and desorb vent 152 (indicated by arrows A).

As discussed above, inlet splitting is the technique where different flow rates are applied to two separate flow paths as the sample tube is desorbed. As is evident from FIG. 1, this example embodiment incorporates inlet splitting since analytes desorbed from the tube 132 are split at the rotary valve 150 with one flow path leading to the trap 134 (and out desorb vent 152) and the other flow path leading out inlet vent 156. The analytes are therefore split in proportion with the ratio of the two flow paths (the paths through the trap 134 and out the inlet vent 156). Instrument hardware limitations typically determine the maximum obtainable split ratio. For example, the ratio often may be determined by the high flow rate out the inlet vent 156 and the low flow rate through the trap 134. Lower trap flow rates allow for higher split ratios (which may be desirable to prevent overload of the analytical column), but will require a longer tube 132 desorption time as the carrier gas will be traveling at a low flow rate to (and through) the trap 134.

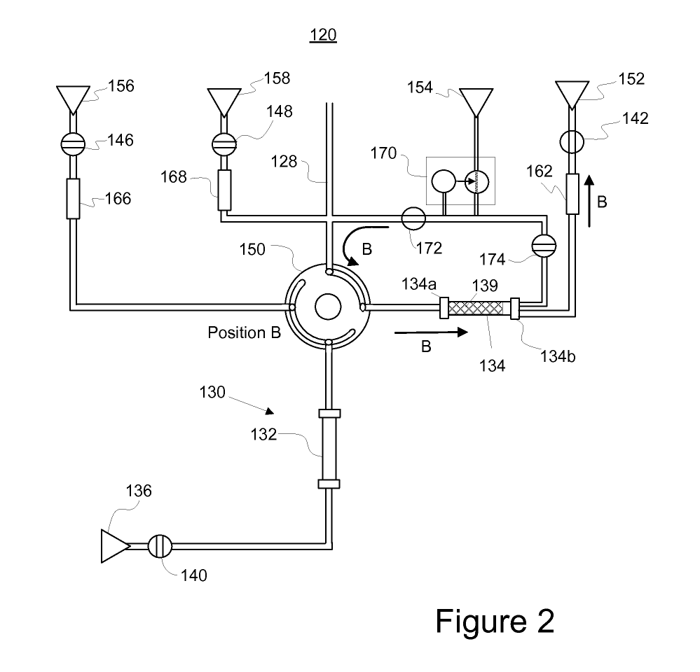

Consequently, there may be very little gas flow (a low flow rate) through the trap 134 during desorption of the tube 132. Therefore, the analytes may not travel very far into the trap adsorbents (and may not be immobilized on the adsorbent of the trap 134) as is illustrated schematically FIG. 2, which depicts the analytes 139 more densely dispersed on the first side 134a of the trap 134. In other words, due to the low flow rate during tube desorption (caused by the inlet splitting) there has been an insufficient total volume of carrier gas to sufficiently transport the analytes into the adsorbent bed of the trap 134 where they would be immobilized. Consequently, as discussed above, during flow equilibration (e.g., when the rotary valve 150 is rotated from position A to position B), some of the analytes could be carried out of the trap 134 and into the transfer line 128 causing a pre-injection and double peaks in the chromatography. Consequently, example embodiments of the present invention “push” the analytes further into the trap 134 at the end of tube desorption via use of a “push cycle.” In other words, in example embodiments of the present invention, a push cycle is used so that the total volume of carrier gas is increased to sufficiently transport the analytes into the adsorbent bed where they are immobilized.

To perform the push cycle, the rotary valve 150 is rotated to position B as shown in FIG. 2 so that the trap 134 is in fluid communication with the transfer line 128. Valve 148 is closed, valve 174 remains closed, and valves 142 and 172 remain opened. Valves 140 and 146 are shown closed although their configuration is not relevant because they are not in the flow path. The position Carrier gas from the carrier inlet 154 is introduced to the system 120 at a predetermined pressure by PPC 170 and passes through valve 172 to transfer line 128. Once in the transfer line 128 some of the gas may exit through the transfer line 128 and some will flow through the rotary valve 150, into the first side 134a of the trap 134, pass through the trap 134 as indicated by arrows B to push the analytes further into the trap 134 (and more fully immobilize the analytes in adsorbent bed of the trap 134). The carrier gas flows out the second side 134b of the trap 134, through charcoal trap 162, valve 142 and desorb vent 152 (as indicated by arrows B). In some embodiments, it may be desirable to open valve 148 to allow some of the carrier gas to escape through outlet vent 158 during the push cycle.

The carrier gas passing through trap 134 in the configuration illustrated in FIG. 2 “pushes” the analytes 139 further into the trap 134 at the end of tube 132 desorption, which (as is illustrated schematically) are more evenly dispersed throughout the adsorbent bed of the trap 134 than prior to the push cycle. Consequently, the analytes are more fully immobilized and, during flow equilibration, analytes are less likely to be carried out of the trap 134 and into the transfer line 128 causing a pre-injection and double peak in the chromatography. In some embodiments, the PPC 170 may introduce carrier gas into the transfer line 128 prior to rotation of the rotary valve 150 from position A to position B to ensure that the column always has carrier gas flowing through it, because during analysis the column can be heated and, if an inert carrier gas is not present, the column film may degrade.

In this example embodiment, the second (different) carrier gas source (carrier gas inlet 154) isolates the analytes from changes in the desorb flow which could otherwise adversely effect the desorption split ratio. Thus, the user may set the flow rate from PPC 170 for maximum productivity instead of being constrained to the lower flow rate available during tube desorption (due to inlet split ratio requirements). In some embodiments, the user may input a flow rate and time to the PPC 170 that will push the analytes sufficiently into the trap 134 to be substantially immobilized. As an example, if the user enters 30 ml/min for thirty seconds the analytes will be pushed with 15 ml of carrier gas. To push the analytes in the same manner from inlet 136 might take fifteen minutes because the user may be limited to a typical 1 ml/min flow rate due to the split ratio requirements. Thus, in some embodiments one advantage in changing the source of the carrier gas is that there is a significant decrease in the tube desorption time required, thus decreasing the overall cycle time of the instrument. In one embodiment, the flow rate through the trap 134 in the first direction during the push cycle (FIG. 2) from the second carrier gas inlet 154 is greater than the flow rate through the trap 134 during tube 132 desorption (FIG. 1) by a factor of at least three, while in some embodiments it can be by a factor of at least ten, at least twenty, at least fifty, or even a factor of at least one hundred.

In some embodiments, the configuration illustrated by FIG. 2 also may be used to perform a purge to remove moisture (e.g., a dry purge) such as, for example, prior to the desorption of tube 132 (illustrated in FIG. 1). Typically, however, the dry purge is done during the tube 132 purge.

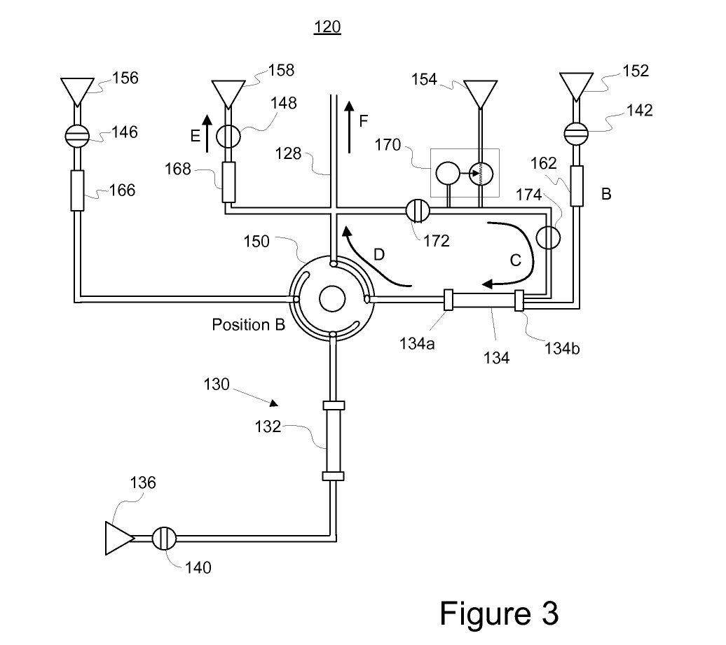

FIG. 3 illustrates a configuration of the thermal desorption unit 120 used for the desorption of the analytes from the trap 134 in which valves 140 and 146 remain closed, and rotary valve 150 remains in position B. Valves 172 and 142 are closed and valves 148 and 174 are opened. The trap 134 may be heated in order to desorb the analytes therefrom. Carrier gas from the second carrier inlet 154 is introduced to the system 120 at a predetermined pressure by PPC 170 and passes through valve 174 and through the trap 134 (indicated by arrow C), where the gas sweeps the desorbed analytes out of the trap 134, through the rotary valve 150 (as indicated by arrow D) and into the transfer line 128 (indicated by arrow F) to the column. Some of the carrier gas and analytes will also flow through charcoal trap 168, valve 148 and out outlet vent 158 (as indicated by arrow E). The analytes traveling through the transfer line 128 will then be analyzed.

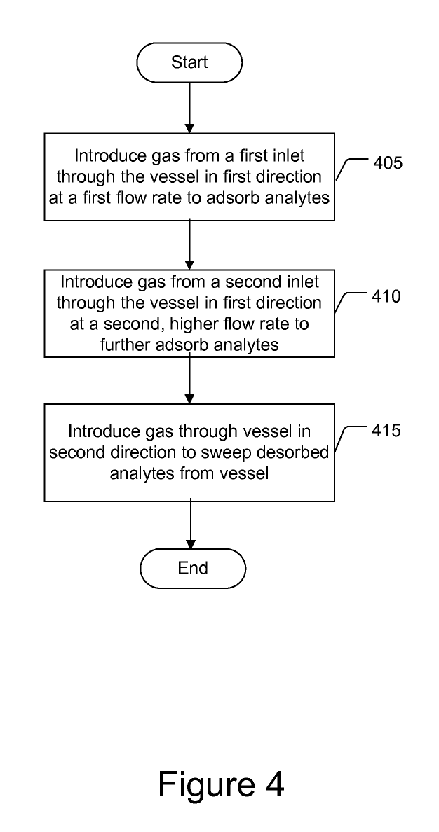

FIG. 4 illustrates a method of providing flow control according to an example embodiment of the present invention. At 405 the process includes introducing a gas from a first gas inlet through the vessel, such as trap 134, in a first direction at a first flow rate to adsorb the analytes into the adsorbent of the vessel. As discussed above, the flow rate may be determined, at least in part, by the inlet split ratio of the hardware configuration. At 410 the process includes introducing a gas from a second gas inlet through the vessel in the first direction at a second, higher flow rate to further adsorb the analytes (i.e., to push the analytes further into the vessel and more fully immobilize the analytes in the adsorbent bed of the vessel). At 415 the process includes introducing gas through the vessel in a second direction, such as while heating the vessel, to sweep desorbed analytes from the vessel, which may be transferred via a transfer line to a gas chromatography system.

The valves used to implement various embodiments of the present invention may be any suitable valve such a needle valve, which may be controlled via solenoid. The carrier gases may be any gas suitable for the intended process including, for example, nitrogen, helium, hydrogen, argon or a mixture such as air or methane. In some embodiments, the transfer line 128 may also be heated during the desorption of trap 134 (illustrated in FIG. 3). The vessels described herein, including trap 134, may include one, two or more adsorbents and may comprise any suitable adsorbent material such as carbon black and may include for example, one or more of the following commercially available materials: Tenax™ TA 60/80, Tenax™ GR 60/80, Carbopack™ B 60/80, Carbopack™ C 60/80, Chromasorb™ 106, Carbosieve™ SIII 60/80. While a tube 132 is used in the above illustrative examples, in other embodiments a canister or headspace vial may be used. In other embodiments, a sample of the surrounding atmosphere (or other gas source) may be pumped directly into the system 120 via inlet 136 thereby eliminating the need for tube 132. While in the example embodiment described above the second carrier inlet 154 is used to both push the analytes further into the trap 134 and also to sweep the desorbed analytes from the trap 134, in other embodiments different carrier gas inlets may be used to push the analytes further into the trap 134 and to sweep the desorbed the analytes from the trap 134. While in the example embodiment described above two carrier gas inlets are used, in other embodiments only one carrier gas inlet is used and is selectively in fluid communication with the desired entry points to the system 120 (e.g., valves 140, 172, and 174) through appropriate flow control mechanisms. While the embodiments described herein include a rotary valve 150 other embodiments may include one or more different flow control mechanisms. While the above embodiments have been described as incorporating certain components and features, the present invention is not so limited. For example, while the example embodiment described above comprises a double splitting outlet configuration (in which both the inlet and outlet are split), other embodiments of the present invention may be used in split inlet systems (without a split outlet, such as where outlet vent 158 is omitted), split output systems (without a split inlet such as where inlet vent 156 is omitted), and where neither the inlet nor the outlet is split (e.g., omitting vents 156 and 158). In other words, embodiments of the present invention may be designed to provide a greater flow rate through the trap to overcome lower flow rates not related the configuration of the system 120 and/or for other reasons.

From the above description, it will be evident that one embodiment of the present invention comprises a flow control system that comprises a first inlet; a first vent; a first vessel having at least one adsorbent disposed therein, a first flow path by which carrier gas is communicated through said first vessel in a first direction from said first inlet to said first vent, wherein carrier gas flows at a first flow rate through said first vessel via said first flow path; a second inlet; a second flow path by which carrier gas is communicated through said first vessel in the first direction from said second inlet to said first vent, wherein carrier gas flows at a second flow rate through said first vessel via said second flow path and wherein said second flow rate is greater than said first flow rate; and a third flow path through which carrier gas is communicated through said first vessel in a second direction; wherein said at least one adsorbent adsorbs analytes when carrier gas carrying a sample mixture containing the analytes flows through said first vessel in the first direction; and wherein a quantity of desorbed analytes are carried out of said first vessel when carrier gas flows through said first vessel in the second direction. The system may further comprise a second vessel forming part of said first flow path and disposed between said first vessel and said first inlet; and, an inlet vent to vent gas from said first inlet and in fluid communication with said first flow path between said first vessel and said second vessel; wherein carrier gas flowing through said first flow path carries analytes from said second vessel to said first vessel for adsorption; and wherein gas flowing through said second flow path does not flow through said second vessel. Said second flow rate of carrier gas through said first vessel may be greater than said first flow rate of carrier gas through said first vessel by a factor of at least three or ten.

Another example embodiment of the present invention may comprise a flow control system, comprising a first flow path in which gas flows from a first inlet, through a first vessel in a first direction at a first flow rate to adsorb analytes on an adsorbent of said first vessel; a second flow path in which gas flows from a second inlet, through said first vessel in the first direction at a second flow rate to adsorb analytes on the adsorbent of said first vessel; and, a third flow path in which a carrier gas flows through said first vessel in a second direction to carry desorbed analytes out of said first vessel; wherein the second flow rate is greater than the first flow rate. The flow control system may further comprise a second vessel disposed between said first vessel and said first inlet and forming part of said first flow path; and, an inlet vent to vent gas from said first inlet, and in fluid communication with said first flow path between said first vessel and said second vessel; wherein carrier gas flowing through said first flow path carriers analytes from said second vessel to said first vessel for adsorption; and wherein carrier gas flowing through said second flow path does not flow through said inlet vent or said second vessel. The second flow rate of carrier gas through said first vessel may be greater than the first flow rate by a factor of at least three or at least ten.

Yet another embodiment of the present invention may comprise a method of providing flow control that comprises introducing a first flow of carrier gas from a first inlet through a first vessel at a first flow rate in a first direction to adsorb analytes on an adsorbent of the first vessel; introducing a second flow of carrier gas from a second inlet through the first vessel at a second flow rate in the first direction to adsorb analytes on the adsorbent of the first vessel; and, introducing a third flow of carrier gas through the first vessel in a second direction to carry desorbed analytes out of the first vessel; wherein the second flow rate is greater than the first flow rate. In some embodiments, prior to flowing through the first vessel, the first flow of carrier gas flows through a second vessel to carry analytes desorbed from the second vessel to the first vessel for adsorption of the analytes on the adsorbent of the first vessel. The method may further comprise venting a portion of the first flow of carrier gas flowing out of the second vessel out an inlet vent and wherein said portion of the first flow of carrier gas does not flow through the first vessel; and wherein the second flow of carrier gas does not flow through the inlet vent or the second vessel. A flow rate of the second flow of carrier gas through the first vessel may be greater than a flow rate of the first flow of carrier gas through the first vessel by factor of at least three, at least ten, or at least twenty.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A flow control system, comprising:
a first inlet;
a first vent;
a first vessel having at least one adsorbent disposed therein,
a first flow path by which carrier gas is communicated through said first vessel in a first direction from said first inlet to said first vent, wherein carrier gas flows at a first flow rate through said first vessel via said first flow path;
a second inlet;
a second flow path by which carrier gas is communicated through said first vessel in the first direction from said second inlet to said first vent, wherein carrier gas flows at a second flow rate through said first vessel via said second flow path and wherein said second flow rate is greater than said first flow rate; and,
a third flow path through which carrier gas is communicated through said first vessel in a second direction;
wherein said at least one adsorbent adsorbs analytes when carrier gas carrying a sample mixture containing the analytes flows through said first vessel in the first direction; and
wherein a quantity of desorbed analytes are carried out of said first vessel when carrier gas flows through said first vessel in the second direction.

2. The flow control system according to claim 1, further comprising:
a second vessel forming part of said first flow path and disposed between said first vessel and said first inlet; and,
an inlet vent to vent gas from said first inlet and in fluid communication with said first flow path between said first vessel and said second vessel;
wherein carrier gas flowing through said first flow path carries analytes from said second vessel to said first vessel for adsorption; and
wherein gas flowing through said second flow path does not flow through said second vessel.

3. The flow control system according to claim 2, further comprising:
a transfer line forming a portion of said third flow path, and
an outlet vent in fluid communication with said transfer line to vent gas a portion of the carrier gas flowing through said transfer line.

4. The flow control system according to claim 1, wherein said second flow rate is greater than said first flow rate by a factor of at least three.

5. The flow control system according to claim 1, further comprising a heating device for heating said first vessel.

6. The flow control system according to claim 1, wherein said second flow rate of carrier gas through said first vessel is greater than said first flow rate of carrier gas through said first vessel by a factor of at least ten.

7. A flow control system, comprising:
a first flow path in which gas flows from a first inlet, through a first vessel in a first direction at a first flow rate to adsorb analytes on an adsorbent of said first vessel;
a second flow path in which gas flows from a second inlet, through said first vessel in the first direction at a second flow rate to adsorb analytes on the adsorbent of said first vessel; and,
a third flow path in which a carrier gas flows through said first vessel in a second direction to carry desorbed analytes out of said first vessel;
wherein the second flow rate is greater than the first flow rate.

8. The flow control system according to claim 7, further comprising:
a second vessel disposed between said first vessel and said first inlet and forming part of said first flow path; and,
an inlet vent to vent gas from said first inlet, and in fluid communication with said first flow path between said first vessel and said second vessel;
wherein carrier gas flowing through said first flow path carriers analytes from said second vessel to said first vessel for adsorption; and
wherein carrier gas flowing through said second flow path does not flow through said inlet vent or said second vessel.

9. The flow control system according to claim 8, wherein said third flow path further comprises a transfer line to communicate analytes desorbed from said first vessel and an outlet vent in fluid communication with said transfer line to vent gas from said second inlet.

10. The flow control system according to claim 7, wherein the second flow rate is greater than the first flow rate by a factor of at least three.

11. The flow control system according to claim 7, wherein the second flow rate is greater than the first flow rate by a factor of at least ten.

12. A method of providing flow control, comprising:
introducing a first flow of carrier gas from a first inlet through a first vessel at a first flow rate in a first direction to adsorb analytes on an adsorbent of the first vessel;
introducing a second flow of carrier gas from a second inlet through the first vessel at a second flow rate in the first direction to adsorb analytes on the adsorbent of the first vessel; and,
introducing a third flow of carrier gas through the first vessel in a second direction to carry desorbed analytes out of the first vessel;
wherein the second flow rate is greater than the first flow rate.

13. The method according to claim 12, wherein prior to flowing through the first vessel, the first flow of carrier gas flows through a second vessel to carry analytes desorbed from the second vessel to the first vessel for adsorption of the analytes on the adsorbent of the first vessel.

14. The method according to claim 13, further comprising:
venting a portion of the first flow of carrier gas flowing out of the second vessel out an inlet vent and wherein said portion of the first flow of carrier gas does not flow through the first vessel; and
wherein the second flow of carrier gas does not flow through the inlet vent or the second vessel.

15. The method according to claim 13, wherein said introducing a third flow of carrier gas comprises introducing the third flow of carrier gas through the first vessel in a second direction to carry desorbed analytes from the adsorbent of the first vessel to a transfer line.

16. The method according to claim 15, further comprising venting a portion of the third flow of carrier gas from the transfer line out an outlet vent.

17. The method according to claim 12, wherein a flow rate of the second flow is greater than a flow rate of the first by factor of at least three.

18. The method according to claim 12, wherein a flow rate of the second flow is greater than a flow rate of the first flow by factor of at least ten.

19. The method according to claim 12, wherein said introducing a third flow of carrier gas comprises introducing the third flow of carrier gas through the first vessel in a second direction to carry desorbed analytes from the adsorbent of the first vessel to be received by a gas chromatograph system.

20. The method according to claim 19, further comprising heating the first vessel during at least a portion of a time period during which the third flow of carrier gas through the first vessel is introduced.
